(19) United States
(12) Patent Application Publication
(10) Pub. No.: US 2014/0026852 A1
(43) Pub. Date: Jan. 30, 2014

(54) COMBUSTION CONTROL WITH EXTERNAL EXHAUST GAS RECIRCULATION (EGR) DILUTION

(71) Applicant: Robert Bosch GmbH, Stuttgart (DE)

(72) Inventors: Li Jiang, Ann Arbor, MI (US); Jeffrey S. Sterniak, Canton, MI (US); Jason Schwanke, Southfield, MI (US)

(73) Assignee: Robert Bosch GmbH, Stuttgart (DE)

(21) Appl. No.: 13/951,658

(22) Filed: Jul. 26, 2013

Related U.S. Application Data
(60) Provisional application No. 61/676,729, filed on Jul. 27, 2012.

(51) Int. Cl. F02D 41/30

(52) U.S. Cl. CPC F02D 41/30
USPC 123/344

(57) ABSTRACT

Methods and system are described for controlling the performance of a vehicle engine in multiple combustion modes. A first engine control variable is identified that has primary control authority of a first engine performance variable—such as, for example, combustion phasing—in a first engine combustion mode. The first engine performance variable is then adjusted by adjusting the first engine control variable when operating in the first engine combustion mode. A second engine control variable is identified that has primary control authority of the first engine performance variable in a second engine combustion mode. The first engine performance variable is adjusted by adjusting the second engine control variable when operating in the second engine combustion mode.

### RELATED APPLICATIONS

The present application claims priority to U.S. Provisional Application No. 61/676,729 filed on Jul. 27, 2012, the entire contents of which are incorporated herein by reference.

### BACKGROUND

The present invention relates to regulating combustion performance in an internal combustion engine with dilution from external exhaust gas recirculation (EGR).

### SUMMARY

The systems and methods described below regulate combustion performance in an internal combustion engine with dilution from external exhaust gas recirculation. Depending on the ability of an actuator to affect a specific performance characteristic of a vehicle engine in a desired combustion mode (i.e., the “control authority” of the actuator), the system coordinates the available actuators to achieve desired performance during steady-state and transient operations. These methods can be applied for combustion modes in which external and internal EGR are required to be coordinated to achieve the performance targets with actuators of different dynamics. These systems and methods improve engine performance under low-temperature combustion modes during transient and steady-state operations, and ease the transition between two combustion modes.

In one embodiment, the invention provides a method of controlling performance of a vehicle engine in multiple combustion modes. A first engine control variable is identified that has primary control authority of a first engine performance variable—such as, for example, combustion phasing—in a first engine combustion mode. The first engine performance variable is then adjusted by adjusting the first engine control variable when operating in the first engine combustion mode. A second engine control variable is identified that has primary control authority of the first engine performance variable in a second engine combustion mode. The first engine performance variable is adjusted by adjusting the second engine control variable when operating in the second engine combustion mode.

In some embodiments, the engine control variables that have primary control authority of a given engine performance variable are identified experimentally by measuring a change in the engine performance variable caused by adjusting each of a plurality of engine control variables and identifying the engine control variable that most directly controls the engine performance variable.

In one embodiment, the invention provides a method of identifying and coordinating actuators in the air, fuel, and ignition subsystems of a vehicle engine in order to achieve desired combustion phasing and torque performance.

In another embodiment, the invention provides a method of a method of controlling the combustion phasing of a vehicle engine. In one embodiment, while operating in a lean HCCI combustion mode, the vehicle control system adjusts the exhaust vale closing timing to regulate average combustion phasing for the engine and adjusts the start time of fuel injection to provide cylinder balancing. In some embodiments, while operating in a SACI combustion mode, the system adjusts the EGR valve position to regulate average combustion phasing for the engine and adjusts the spark timing to provide cylinder balancing. In some embodiments, while operating in a standard spark ignition combustion mode, the system adjusts spark timing to control combustion phasing.

In some embodiments, the invention provides a method of controlling the torque of the vehicle engine. When operating in the lean HCCI combustion mode, the vehicle control system adjusts the fuelling level to control the engine torque. When operating in the stoichiometric SACI combustion mode, the system adjusts the exhaust vale closing timing to control the engine torque. When operating in a standard spark ignition combustion mode, the system adjusts the throttle, the turbo-charger waste-gate valve, and the spark timing to control the engine torque.

In one embodiment, the invention provides an engine management system with associated actuators and sensors to enable combustion control of a vehicle engine. In another embodiment, the invention provides a control strategy to coordinate vehicle engine actuators to obtain desired combustion performance taking into consideration the control authorities of the actuators under different combustion modes. In yet another embodiment, the invention provides a control strategy to coordinate the actuators in the air path subsystem of a vehicle engine, including the throttle, valve-train (exhaust valve timing), and the EGR valve to drive demanded EGR dilution in a timely manner. In still another embodiment, the invention provides a real-time control system, integrating model-based feed-forward and cylinder pressure sensing feedback strategies, to realize transient and steady-state operations over a variety of environmental conditions.

Other aspects of the invention will become apparent by consideration of the detailed description and accompanying drawings.

### BRIEF DESCRIPTION OF THE DRAWINGS

FIG. 1 is a schematic diagram of an engine controlled by a vehicle control system according to one embodiment.

FIG. 1A is a block diagram of the engine system of FIG. 1 including an engine control unit (ECU).

FIG. 2 is a flowchart illustrating a method of performing a control sensitivity analysis of the engine system of FIG. 1.

FIG. 3 is a graph illustrating the effect of spark timing on combustion phasing for an engine operating in a spark assisted compression ignition (SACI) combustion mode.

FIG. 4 is a graph illustrating the effect of spark timing on combustion output torque for an engine operating in a stoichiometric SACI combustion mode.

FIG. 5 is a series of graphs illustrating the impact on engine performance of varying internal EGR and external EGR.

FIG. 6 is a table illustrating the optimal actuators used to regulate engine performance in one engine system using a lean HCCI mode, a stoichiometric SACI mode, and a SI mode.

FIG. 7 is a table illustrating the optimal actuators used to regulate engine performance in one engine system using a stoichiometric HCCI mode and a lean SACI mode.

FIG. 8 is a flowchart of a method of operating an engine based on the control strategy defined by FIGS. 6 and 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

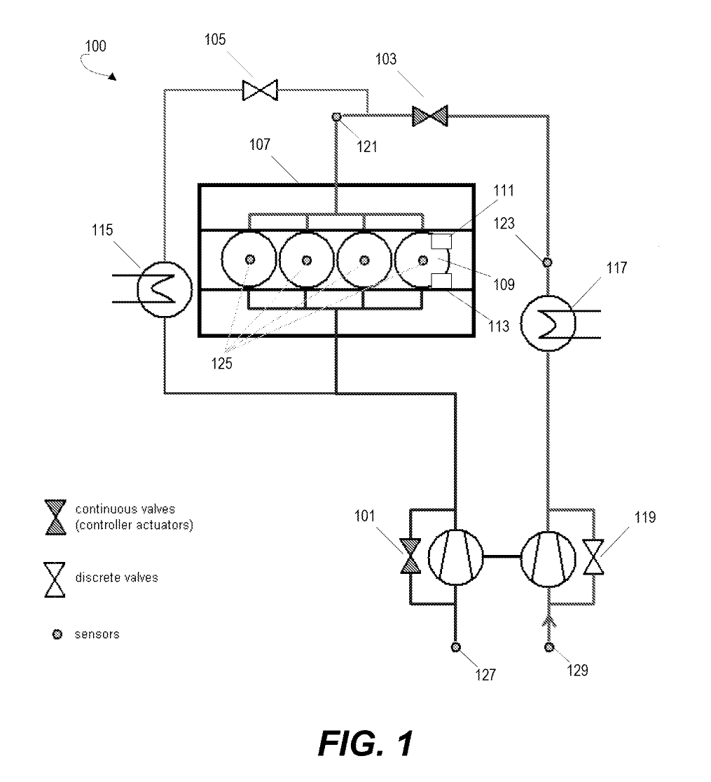

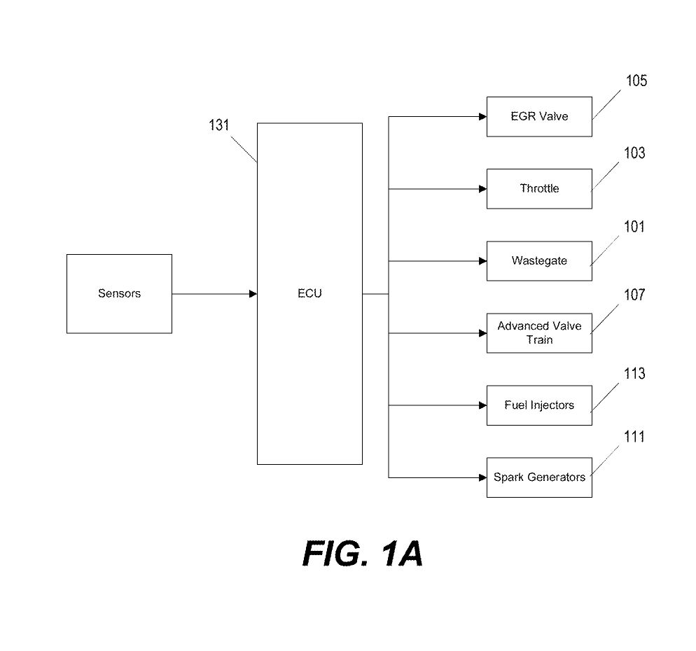

FIG. 1 illustrates an example of an engine configuration 100 for a multi-mode combustion engine capable of operating in a homogeneous charge compression ignition (HCCI) combustion mode, a spark assisted compression ignition (SACI) combustion mode, and a standard spark ignition (SI) combustion mode. Equipped with a turbo-charger, the key actuators in the air path include a turbocharger waste-gate 101, a throttle 103, an external exhaust gas recirculation (EGR) valve 105, and the advanced valve train 107. In order to enable low-temperature combustion modes including SACI and HCCI, the advanced valve-train 107 could consist of either (1) cam profile switching and electric cam phasing or (2) a fully flexible valve-train. The advanced valve train 107, among other things, controls the intake and exhaust valves of each individual cylinder 109. Each individual cylinder 109 is also fitted with a controllable spark generator 111 and a fuel injector 113. The engine also includes an EGR cooler 115, an intercooler 117, and a dump valve 119.

In addition to a temperature sensor 121 and a pressure sensor 123 positioned in the air path, the engine system is also equipped with individual cylinder pressure sensors 125. An oxygen sensor 127 is position in both the exhaust and intake manifolds and a hot-film mass air flow sensor 129 measures the intake air flow rate. As further illustrated in FIG. 1A, the engine system includes an engine control unit (ECU) 131 that coordinates the actuators to achieve certain performance criteria, such as combustion phasing and torque. The ECU 131 can be implemented in a variety of ways including, for example, a controller including a processor and a memory that stores instructions which are executed by the processor to control the operation of the ECU 131. The ECU 131 receives input from the plurality of sensors incorporated into the engine system and determines engine performance variables (e.g., combustion phasing and torque) based on the input from the plurality of sensors. The ECU 131 then determines an appropriate engine control variable for each engine actuator and provides a plurality of control outputs. The engine actuators include, for example, the EGR valve 105, the throttle 103, the turbocharger wastegate 101, the advanced valve train 107, and the fuel injectors 113 and spark generators 111 for each engine cylinder.

As noted above, the engine system 100 is capable of operating in a number of different engine combustion modes. Although the ECU 131 is able to adjust the engine control variables provided to the engine actuators in order to control/adjust the engine performance variables, the degree to which individual control variables correlate to engine performance variables can vary depending upon certain driving conditions and the current engine combustion mode. As used herein, engine control variables include actuator settings or other variables that are directly controlled, for example, by an ECU 131 while engine performance variables include engine conditions that are observed, for example, based on data from sensors or other known engine conditions.

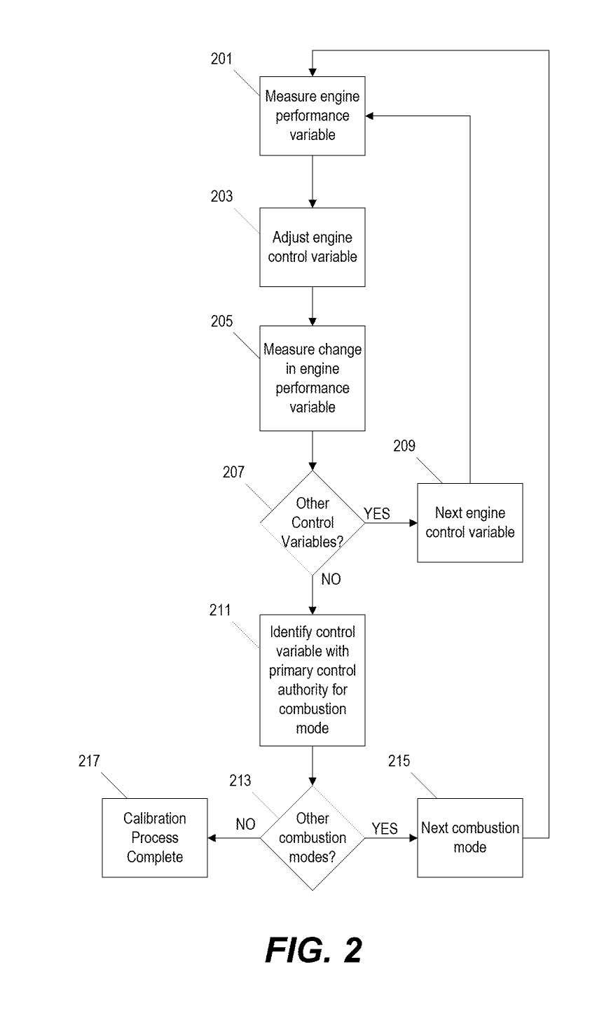

In order to optimize operation of the engine system, experimental analysis is performed to determine the control authority that each engine actuator has over certain performance variables under each combustion mode. FIG. 2 illustrates one example of such a control sensitivity analysis for a single engine performance variable. The ECU 131 begins by measuring the first engine performance variable (step 201). The ECU 131 then adjusts the value of the engine control variable that is sent from the ECU 131 to the engine actuator (step 203). The ECU 131 monitors the change in the engine performance variable relative to the change in the engine control variable (step 205). If other engine control variables remain to be tested (step 207), the ECU 131 advanced to the next engine control variable (step 209) and repeats steps 201-205.

Once the sensitivity of each engine control variables have been analyzed in the first combustion mode (step 207), the ECU 131 identifies the engine control variable that has primary control authority of the engine performance variable for the combustion mode (step 211). The mechanism for determining “primary control authority” can vary depending upon a particular engine, a particular driving condition, or a particular combustion mode. However, primary control authority can be determined by identifying the engine control variable that causes the greatest change in a specific engine performance variable. In other cases, primary control authority is the engine control variable that has the most linear relationship to the engine performance variable or that causes a change in one specific engine performance variable without causing a change in other engine performance variables.

Once an engine control variable is identified as having primary control authority for a specific engine performance variable when operating in an specific engine combustion mode, the ECU 131 determines whether other combustion modes need to be evaluated (step 213). If so, the ECU 131 advances to the next combustion mode (step 215)—e.g., advancing from a standard spark ignition combustion mode to SACI combustion or HCCI combustion—and repeats the process described above for each different combustion mode that can be implemented by the vehicle engine system. Once primary control variables have been identified for each combustion mode, the calibration/control sensitivity analysis process is completed (step 217).

Although FIG. 2 illustrates a generalized example of a control sensitivity analysis process for a single engine performance variable, the process can be readily adapted to determine primary control authority for a plurality of different engine performance variables. For example, the method of FIG. 2 can be completed once for a first engine performance variable and then repeated for a second engine performance variable. Alternatively, the ECU 131 can monitor changes in multiple engine performance variables concurrently as each engine control variable is adjusted.

The control sensitivity analysis can be performed on a vehicle operating in a controlled calibration environment (e.g., a dynamometer or on a closed course) at the time of design/manufacture and the determined control authorities can be defined the same for all vehicles with the same configuration. Alternatively, the control authorities can be evaluated and optimized for a specific vehicle configuration (i.e., a customized vehicle).

Furthermore, in some constructions, the ECU 131 is configured to perform the control sensitivity analysis while the vehicle is operating in real time. For example, if the vehicle is operating in a specific combustion mode (e.g., HCCI) under normal driving conditions, the ECU 131 can periodically adjust one or more of the engine control variables to monitor control sensitivities. Because the operation of a vehicle engine can change over the life of the vehicle system and under certain specific driving conditions, this real-time analysis enables the vehicle to adapt the defined control authorities as they change.

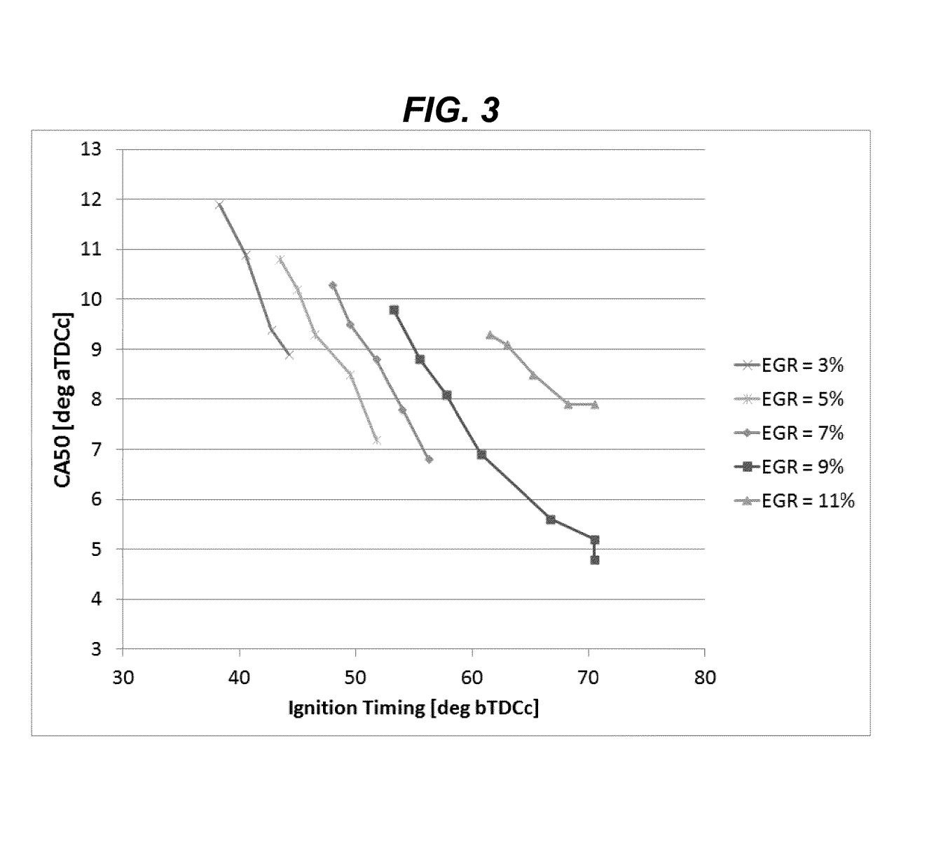

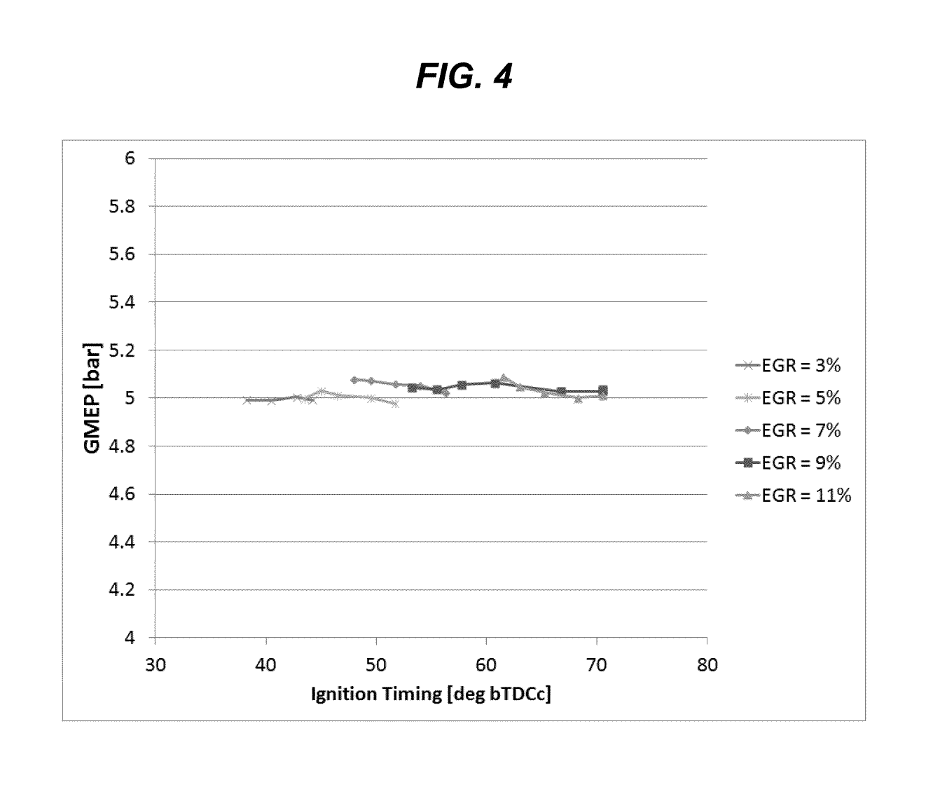

FIGS. 3 and 4 illustrate the measured correlation between various engine performance variables and spark timing during spark-assisted compression ignition (SACI) combustion. The illustrated values were measured when the vehicle was operating under stoichiometric conditions with mixtures of internal residual gas and external recirculated exhaust gas in different ratios. As shown in FIG. 3, during SACI combustion, spark timing has a significant effect on the combustion phasing of the engine. However, as shown in FIG. 4, spark timing has very little impact on the output torque of the engine during SACI combustion. Therefore, given these results, spark timing might be identified as the primary control variable for combustion phasing when operating in the SACI combustion mode, but spark timing would almost certainly not have primary control authority over output torque.

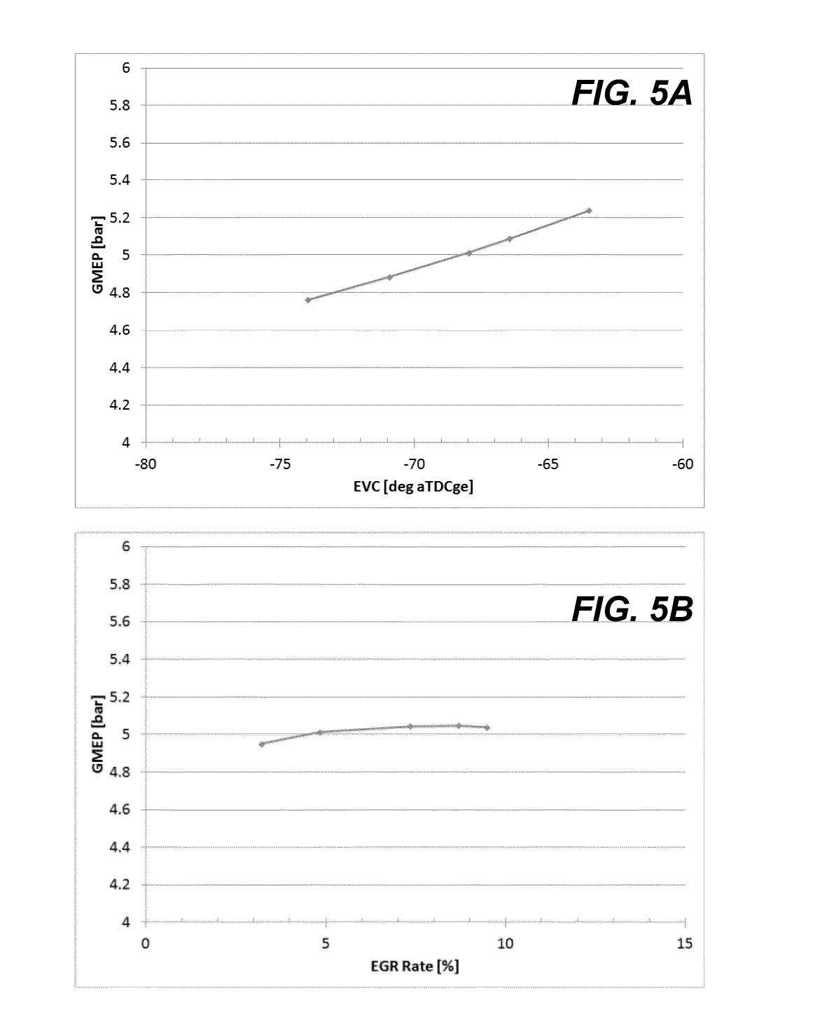

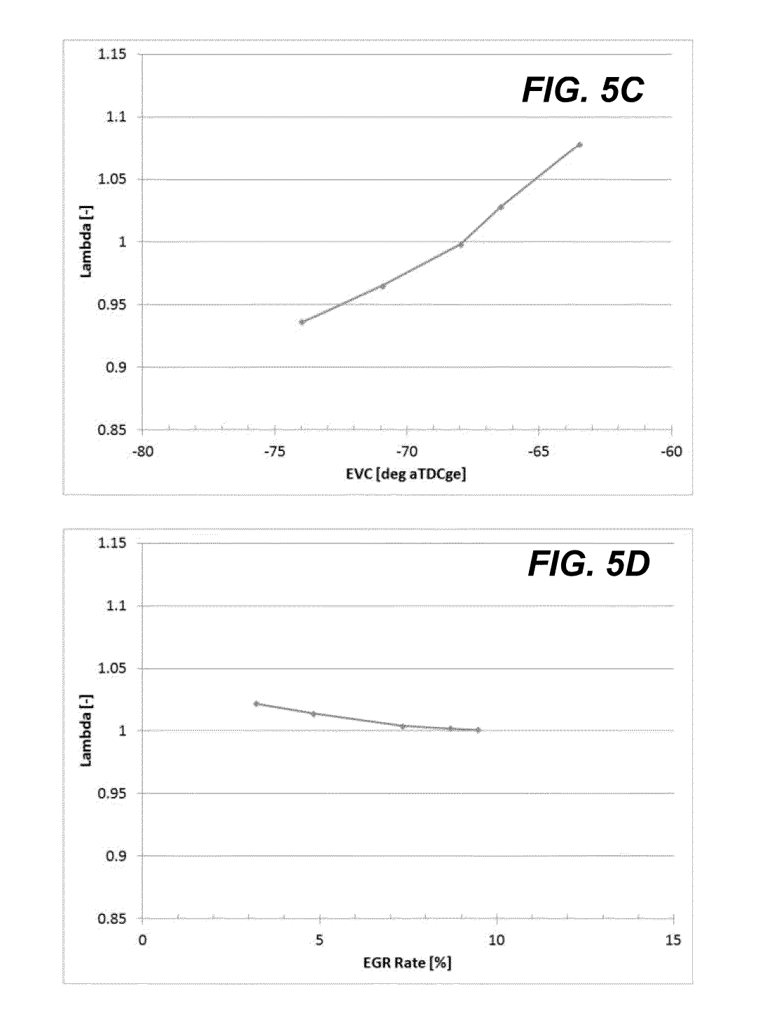

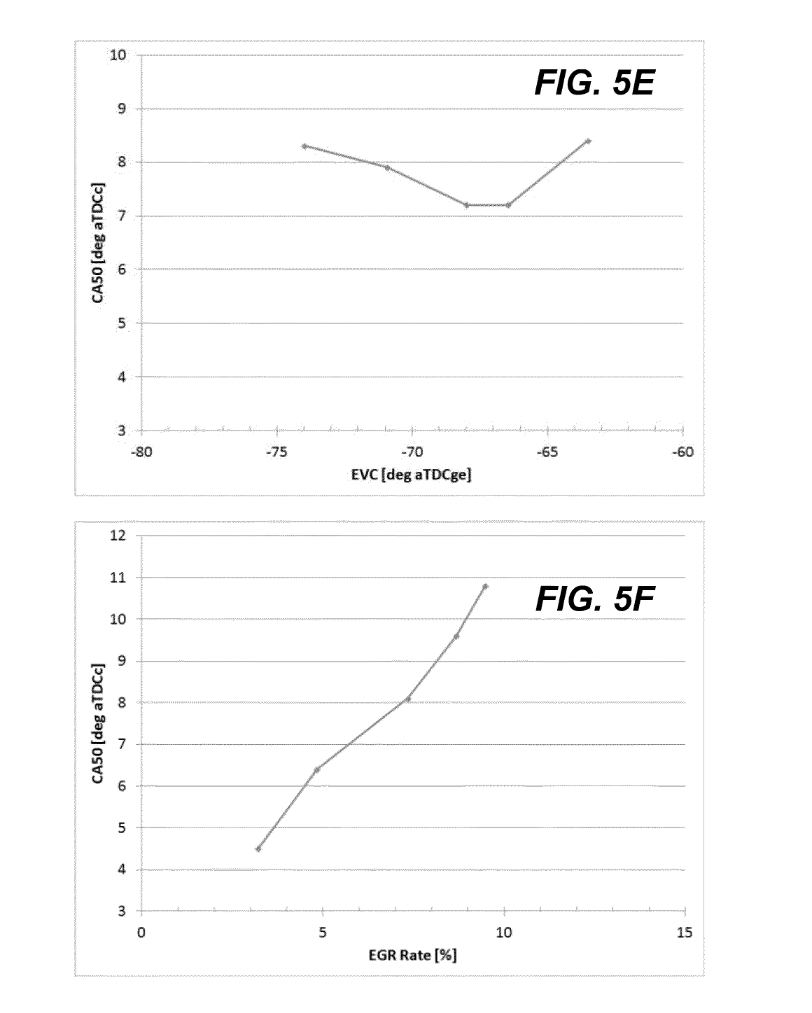

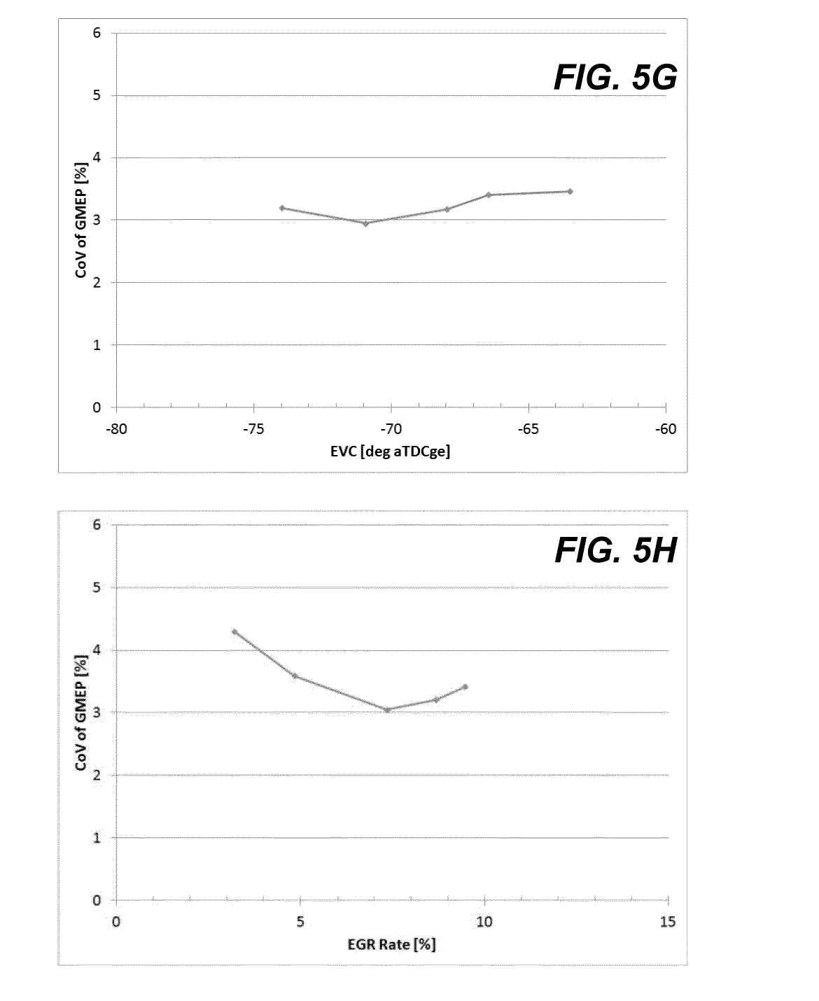

FIG. 5 illustrates in a series of graphs the relative control authority of the timing of exhaust valve closing (EVC) and the EGR valve angle in the same multi-cylinder engine operating under SACI combustion. As illustrated in FIG. 5, the amount of internal EGR regulated via EVC position has stronger impacts on charge composition, which, in turn, impacts the combustion torque due to combustion efficiency. However, in terms of combustion phasing, the amount of external EGR regulated via EGR valve angle has shown stronger impacts. Therefore, EVC timing has more control authority over output torque than EGR valve position, but EGR valve position has more control authority over combustion phasing.

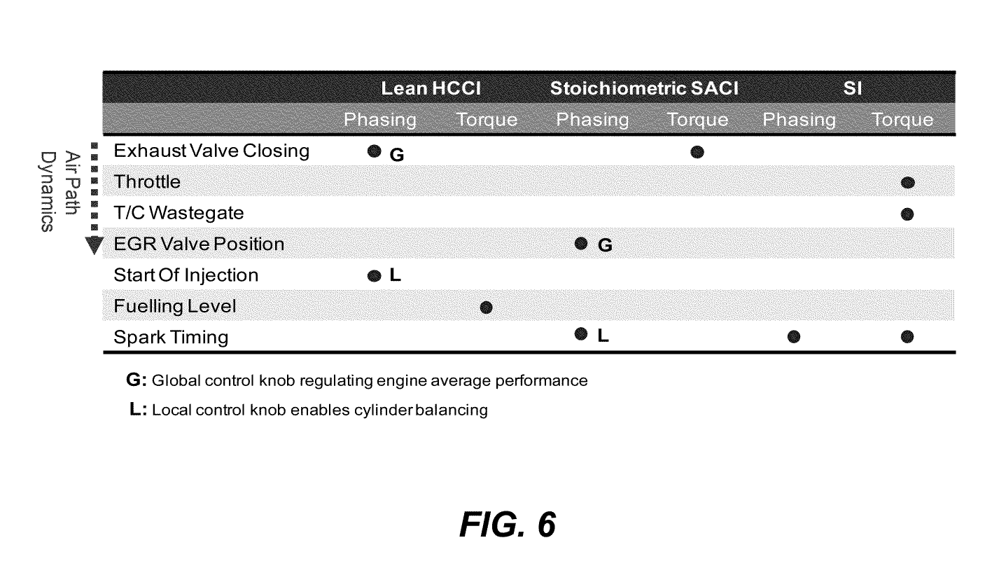

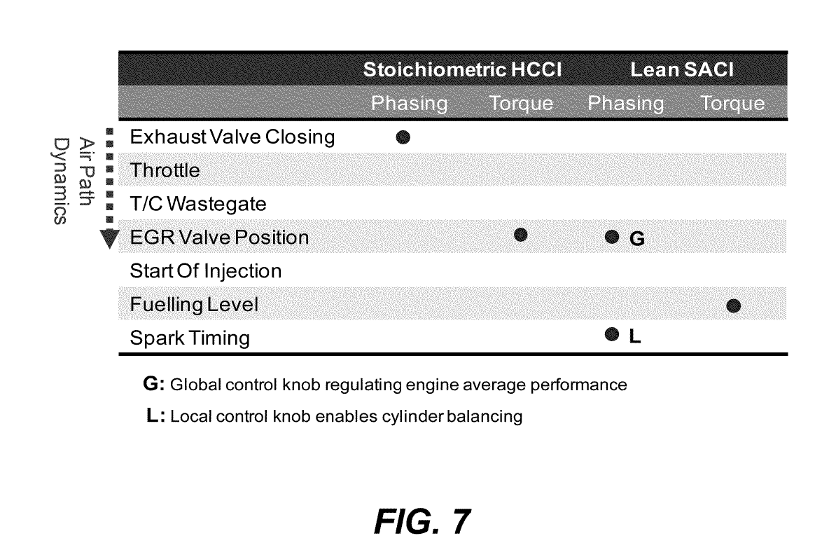

FIGS. 6 and 7 illustrate the engine control variables that have been experimentally identified as having the greatest control authority over the engine performance variables—combustion phasing and output torque—in each of five difference combustion modes. Under a lean HCCI combustion mode, exhaust valve closing and start of injection are identified and validated with experiments to be key control knobs for combustion phasing. However, because fuel injection timing can be more readily adjusted on a per-cylinder level than exhaust valve closing, the control strategy illustrated in FIG. 6 uses the timing of exhaust valve closing as a “global” control to regulate the overall performance of the engine while fuel injection timing is used as a local variable to balance the performance of each individual cylinder in the multi-cylinder engine system.

Under the stoichiometric SACI combustion mode, the control strategy employs the EGR valve as the global controller to regulate average engine combustion phasing performing while leaving sufficient control authority in spark timing as the local actuator to regulate individual cylinder combustion phasing performance for cylinder balancing. However, in the SI combustion mode, spark timing is the only actuator identified as having sufficient control authority over combustion phasing. Therefore, separate local and global controls are not identified in this control strategy.

As further illustrated by FIG. 6, under the lean HCCI combustion mode, the engine torque is directly controlled by the fueling level. Under the stoichiometric SACI and SI combustion modes, the engine torque is directly regulated with actuators in the air path subsystems because, when operating in these combustion modes, the fuel level is bounded to maintain a target air/fuel ratio. As a result, under the stoichiometric SACI combustion mode, the control strategy uses EVC as the key controller to regulate engine torque. Under SI combustion, the throttle and turbo-charger waste-gate are the key control knobs for engine torque. Furthermore, under the SI combustion mode, spark timing, in addition to its impacts on combustion phasing, also affects the engine torque.

FIG. 7 illustrates the control “knobs” for two additional combustion modes for the engine described in the examples above: stoichiometric HCCI and lean SACI. Under the stoichiometric HCCI combustion mode, the exhaust valve closing has significant control authority over combustion phasing. Although not noted as such in the table of FIG. 6, the start of injection may also still be used as a control knob for regulating combustion phasing in stoichiometric HCCI mode. Due to the stoichiometric combustion constraint, while operating in the stoichiometric HCCI combustion mode, the torque is mainly regulated through EGR valve position.

Under the lean SACI combustion mode, the combustion phasing control authority of the EGR valve position and spark timing remain prominent. Start of injection can also be used as an actuator for regulating combustion phasing. However, lean combustion enables the engine torque to be directly controlled by adjusting the fueling level.

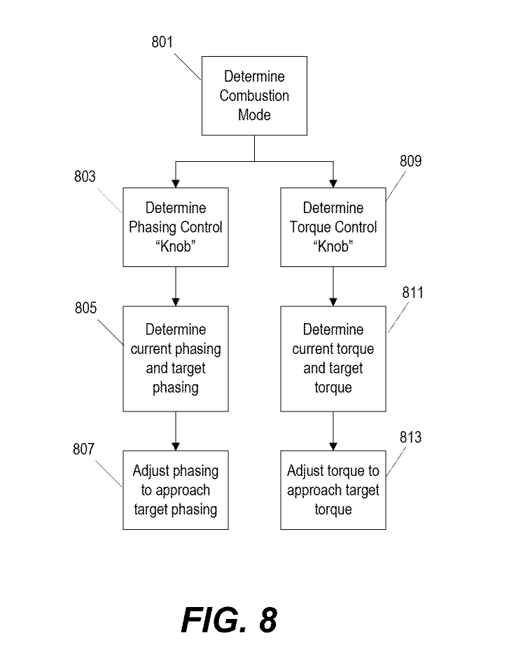

FIG. 8 illustrates a method of controlling the operation of the engine using the experimentally derived control strategy illustrated in FIGS. 6 and 7. The ECU 131 first determines which combustion mode is currently being implemented in the engine (step 801). Then the ECU 131 accesses a stored look-up table illustrating the applicable control strategy, such as the one illustrated in FIGS. 6 and 7. The ECU 131 determines the appropriate “control knob” for combustion phasing in the current combustion mode (step 803). For example, if the engine is operating in the lean HCCI combustion mode the ECU 131 determines that the timing of exhaust valve closing is the appropriate “global” control knob while fuel injection timing is the appropriate “local” control knob.

Once the appropriate control knobs are identified, the ECU 131 determines the current combustion phasing based on the inputs from the engine sensors and determines a target combustion phasing for the engine (step 805). The ECU 131 then adjusts the appropriate control knob(s) to cause the actual combustion phasing to approach the target combustion phasing (step 807).

At the same time, the ECU 131 also consults the stored look-up table to determine the appropriate control knob(s) to adjust the output torque in the current combustion mode (step 809). The ECU 131 determines an actual output torque and a target output torque (step 811) and adjusts the appropriate control knob(s) to cause the actual output torque to approach the target output torque (step 813).

Thus, the invention provides, among other things, a systems and methods for controlling various different engine actuators, depending upon the current combustion mode of the engine, to improve engine performance. Various features and advantages of the invention are set forth in the following claims.

What is claimed is:

1. A method of controlling performance of a vehicle engine in multiple combustion modes, the method comprising:
identifying a first engine control variable that has primary control authority of a first engine performance variable in a first engine combustion mode;
adjusting the first engine performance variable by adjusting the first engine control variable when operating in the first engine combustion mode;
identifying a second engine control variable that has primary control authority of the first engine performance variable in a second engine combustion mode; and
adjusting the first engine performance variable by adjusting the second engine control variable when operating in the second engine combustion mode.

2. The method of claim 1, wherein the first engine performance variable is combustion phasing, and wherein adjusting the first engine performance variable by adjusting the first engine control variable when operating in the first engine combustion mode includes adjusting the combustion phasing by adjusting timing of exhaust valve closing when operating in a homogeneous charge compression ignition combustion mode.

3. The method of claim 2, wherein adjusting the first engine performance variable by adjusting the second engine control variable when operating in the second engine combustion mode includes adjusting the combustion phasing by adjusting spark timing when operating in a spark ignition combustion mode.

4. The method of claim 2, wherein adjusting the first engine performance variable by adjusting the second engine control variable when operating in the second engine combustion mode includes adjusting the combustion phasing by adjusting the combustion phasing by adjusting a position of an external exhaust gas recirculation valve when operating in a spark assisted compression ignition combustion mode.

5. The method of claim 1, wherein the act of identifying the first engine control variable that has primary control authority of the first engine performance variable in the first engine combustion mode includes
adjusting a plurality of engine control variables while operating in the first engine combustion mode, and
identifying an engine control variable of the plurality of engine control variables that causes a corresponding change in an observed value of the first engine performance variable.

6. The method of claim 1, wherein the plurality of engine control variables includes a timing of an exhaust valve closing, a throttle setting, a wastegate setting, an external exhaust gas recirculation valve position setting, a timing of a fuel injection, an amount of fuel injected, and a spark timing.

7. The method of claim 1, further comprising:
identifying a third engine control variable that has primary control authority of a second engine performance variable in the first engine combustion mode;
adjusting the second engine performance variable by adjusting the third engine control variable when operating in the first engine combustion mode;
identifying a fourth engine control variable that has primary control authority of the second engine performance variable in the second engine combustion mode; and
adjusting the second engine performance variable by adjusting the fourth engine control variable when operating in the second engine combustion mode.

8. The method of claim 7, wherein the second engine performance variable is engine torque, and wherein adjusting the second engine performance variable by adjusting the third engine control variable when operating in the first engine combustion mode includes adjusting the engine torque by adjusting an amount of fuel injected into an engine cylinder when operating in a homogeneous charge compression ignition combustion mode.

9. The method of claim 8, wherein adjusting the second engine performance variable by adjusting the fourth engine control variable when operating in the second engine combustion mode includes adjusting the engine torque by adjusting at least one of a throttle setting, a wastegate setting, and a spark timing when operating in a spark ignition combustion mode.

10. The method of claim 1, wherein the first engine combustion mode includes one of a homogeneous charge compression ignition combustion mode, a spark-assisted compression ignition combustion mode, and a spark ignition combustion mode.

11. The method of claim 1, wherein the first engine control variable is used to regulate an average engine performance of each cylinder in a multiple cylinder engine, and further comprising:
identifying a third engine control variable that has primary control authority of the first engine performance variable for an individual cylinder of the multiple cylinder engine in the first engine combustion mode; and
adjusting the first engine performance variable for the individual cylinder by adjusting the third engine control variable.

12. The method of claim 11, wherein the first engine combustion mode includes a homogeneous change compression ignition mode, and wherein the third engine control variable includes a timing of a start of fuel injection into an individual cylinder.

13. The method of claim 11, wherein the first engine combustion mode includes a spark-assisted compression ignition combustion mode, and wherein the third engine control variable includes a spark timing for an individual cylinder.

14. The method of claim 1, wherein the first engine combustion mode includes a lean homogeneous charge compression ignition combustion mode, wherein the first engine performance variable includes combustion phasing, and wherein the first engine control variable includes a timing of exhaust valve closing.

15. The method of claim 1, wherein the first engine combustion mode includes a lean homogeneous charge compression ignition combustion mode, wherein the first engine performance variable includes engine torque, and wherein the first engine control variable includes an amount of injected fuel.

16. The method of claim 1, wherein the first engine combustion mode includes a stoichiometric spark-assisted compression ignition combustion mode, wherein the first engine performance variable includes combustion phasing, and wherein the first engine control variable includes a position setting of an external exhaust gas recirculation valve.

17. The method of claim 1, wherein the first engine combustion mode includes a stoichiometric spark-assisted compression ignition combustion mode, wherein the first engine performance variable includes engine torque, and wherein the first engine control variable includes a timing of an exhaust valve closing.

18. The method of claim 1, wherein the first engine combustion mode includes a spark ignition combustion mode, wherein the first engine performance variable includes combustion phasing, and wherein the first engine control variable includes spark timing.

19. The method of claim 1, wherein the first engine combustion mode includes a spark ignition combustion mode, wherein the first engine performance variable includes engine torque, and wherein the first engine control variable includes at least one of a throttle setting, a wastegate setting, and spark timing.

20. The method of claim 1, wherein the first engine combustion mode includes a stoichiometric homogeneous charge compression ignition combustion mode, wherein the first engine performance variable includes combustion phasing, and wherein the first engine control variable includes a timing of an exhaust valve closing.

21. The method of claim 1, wherein the first engine combustion mode includes a stoichiometric homogeneous charge compression ignition combustion mode, wherein the first engine performance variable includes engine torque, and wherein the first engine control variable includes a position setting of an external exhaust gas recirculation valve.

22. The method of claim 1, wherein the first engine combustion mode includes a lean spark-assisted compression ignition combustion mode, wherein the first engine performance variable includes combustion phasing, and wherein the first engine control variable includes a position setting of an external exhaust gar recirculation valve.

23. The method of claim 1, wherein the first engine combustion mode includes a lean spark-assisted compression ignition combustion mode, wherein the first engine performance variable includes engine torque, and wherein the first engine control variable includes an amount of injected fuel.
